(19) United States
(12) Patent Application Publication
(10) Pub. No.: US 2019/0071911 A1
(43) Pub. Date: Mar. 7, 2019

(54) ACTUATING DRIVE

(71) Applicant: Julius Blum GmbH, Hoechst (AT)

(72) Inventor: Harald BRUNNMAYR, Hoerbranz (AT)

(21) Appl. No.: 16/182,775

(22) Filed: Nov. 7, 2018

Related U.S. Application Data
(63) Continuation of application No. PCT/AT2017/060115, filed on May 4, 2017.

(30) Foreign Application Priority Data
May 13, 2016 (AT) A 50446/2016

(51) Int. Cl. E05F 1/10

(52) U.S. Cl. CPC E05F 1/1058; E05Y 2201/474; E05Y 2201/604; E05Y 2900/20

(57) ABSTRACT

An actuating drive includes an actuating arm to be connected to the furniture part and a force accumulator for applying force to the actuating arm. The force accumulator has a spring and at least two base parts which can be moved relative to each other and between which the at least one spring is arranged. A guiding device is arranged within the spring, and the guiding device is designed in such a way that the guiding device supports the spring against buckling of the spring over the entire length of the spring and in every position of the spring resulting from motion of the at least two base parts relative to each other.

### BACKGROUND OF THE INVENTION

The present invention concerns an actuating drive for driving a movably supported furniture part of an item of furniture, and an item of furniture with at least one such actuating drive.

Actuating drives for driving movably supported furniture parts of an item of furniture with force storage members, in which the springs or spring assemblies of the force storage members comprise guiding devices for preventing buckling movements of the springs in the case of a compression of the force storage member are known from the state of the art. Also guiding devices arranged in the inside of the spring, for example in the form of rods arranged in an inner space formed by the spring, are known. As the distance of the base parts, between which the spring is arranged, in a completely compressed position of the force storage member—and, thus, the possible stroke of such a force storage member—is limited by such inside rods which serve to guide the spring, such a guiding device cannot extend over the whole length of the spring to be supported. For this reason, such force storage member usually and necessarily comprises additional external guiding devices in the form of for example cup-shaped or pot-shaped spring seats which externally enclose the spring in a spacious manner.

The insufficient support of the spring by the guiding device arranged in the inside of the spring is disadvantageous with actuating drives known from the state of the art with previously described force storage members. As a consequence, a buckling of the spring and an insufficient guiding of the force storage member, for example in the case of a compression of the force storage member, can occur. Such a defective guiding can have a negative effect on the spring characteristic and the efficiency of the force storage member. In order to guarantee a sufficient guiding, force storage members of actuating devices known from the state of the art comprise additional structural measures which lead to an increased work effort and material usage as well as to an increased space requirement of such a force storage member (and thus of the actuating drive). Such an insufficient guiding of the spring of a force storage member can lead to an undesired noise generation when operating the actuating drive, as a buckling spring can clatter along an internal or external guiding.

### SUMMARY OF THE INVENTION

The object of the present invention, thus, is to provide an improved actuating drive compared of the state of the art and an item of furniture with at least one such actuating drive. Especially, the above-mentioned disadvantages concerning the noise generation, the space requirement and the efficiency shall be removed.

The set object is solved by an actuating drive and by an item of furniture with at least one such actuating drive. Because the guiding device is designed in such a way that the guiding device supports the at least one spring against buckling of the spring over the entire length of the spring and in every position of the spring resulting from a motion of the at least two base parts relative to each other, in each compression position of the force storage member, wherein each compression position corresponds to a position of the spring, a safe guiding of the spring is guaranteed even in the case of large pre-stresses and high spring rates. If the spring is formed as helical spring, the spring is supported by the guiding device in the case of a compression in such a way that the spring is deformed substantially only along the longitudinal axis of the spring and radially or laterally directed movements of the spring to the movement direction of the relative motion of the at least two base parts are prevented. Such a guiding device can have positive effects on the spring characteristics of the spring. For example, the spring characteristics can run in particular linearly. Also, the efficiency of the spring or the force storage member can be optimized as a substantially straight running relative motion of the at least two base parts can be transformed in a substantially straight, thus free from bucklings, running compression or expansion movement of the spring. Thus, a compact and efficient force storage member can be provided. Also, such a guiding device can contribute to a reduction of disturbing noises when operating the actuating drive, as often suddenly occurring bucklings of the spring(s) can be avoided.

It can be advantageous that the length of the guiding device can be adapted to the length of the at least one spring. As a consequence, the spring can be supported in each position over their whole length against buckling, but the possible change of length of the spring—and thus the possible stroke of the force storage member—is not limited by the guiding device.

Further, an advantageous manner that during the relative motion of the at least two base parts, the guiding device can be moved—at least partly—through one of the base parts. Thereby, a support of the spring over the entire length in every position of the spring and in every position of the two base parts to each other is possible in an easy manner. As a consequence, also the length of the guiding device can easily be adapted to the length of the spring. Moreover, a guiding of the relative motion of the two base parts can be reached and in that way, for example in the case of an appropriate design of the guiding device, a linear guiding of the relative motion of the base parts can be enabled.

It can be advantageous that the actuating drive comprises a housing and the guiding device can be moved through one of the base parts in a direction facing an inner space of the housing. Thereby, a particularly compact construction of the force storage member and, thus, of the actuating drive can be reached, as in the case of an operation of the actuating device no parts of the guiding device or of the force storage member are protruding from the housing of the actuating drive. A base part of the force storage member can mounted in a fixed manner to the housing or can be swivel-mounted to the housing.

It can also be advantageous that the actuating drive comprises a transmission mechanism for the application of force of the at least one actuating arm by the force storage member and the transmission mechanism is cooperating—preferably directly—with the base part, through which base part the guiding device can be moved at least partly. The transmission mechanism can serve for the configuration of the transmission ratio of the force transmitted from the force storage member onto the actuating arm.

It can be of an advantage that the guiding device consists of a first material—preferably plastic material—at least in areas facing towards the spring, wherein the first material is different from the second material and wherein the spring is made of the second material. Thus, for example the coefficient of friction between the guiding device and the spring, especially the inner section of the spring, can be optimized and, thus, also a noise generation can be reduced in the case of a contact of the spring and the guiding device. The guiding device can be formed for example of a plastic material such as polyoxymethylene (POM). It is also possible that the guiding device is made of a metallic material and comprises an appropriate coating in sections facing towards the spring.

Further, it can be advantageous that the guiding device comprises sleeve parts which correspond to each other, wherein the sleeve parts are arranged on the base parts and the sleeve parts are protruding from the base parts and wherein the sleeve parts in each position of the at least two base parts movable relative to each other comprise an at least partial overlap in circumferential direction and/or in radial direction. The sleeve parts corresponding to each other basically can be formed by two axially movable parts which can be arranged at least partly in an overlapping or meshing manner. By an arrangement of the sleeve parts on the base parts, it can be guaranteed that the sleeve parts follow the movements of the base parts. Each sleeve part can also be formed integrally with a basis associated to the guiding device. Such a basis can serve as a support (counter bearing) for the springs too. A play of about 0.1 millimeter in radial direction can be provided between the sleeve parts.

It can be advantageous that the sleeve parts comprise a longitudinal guide, formed by at least one groove which is formed on a sleeve part and by a profile bar formed on the other sleeve part and being formed correspondingly with the groove. As a result, the support of the spring provided by the guiding device can be increased and also the space requirement required by the guiding device inside the spring can be minimized.

It can also be advantageous that the guiding device comprises at least one—preferably bolt-formed—guiding element and at least one guiding opening for the guiding element, wherein the at least one guiding element is arranged on one of the base parts and the guiding opening corresponding to the guiding element is formed on the other base part. The guiding element can reach through a guiding opening in each relative position of the base parts of a force storage member in a mounting position, thus, with a force storage member installed in the actuating drive. Further, a guiding of the relative motion of the base parts to each other can be reached by a guiding device formed in such a way.

Basically, it can be advantageous that the guiding element can be arranged at least partly in one of the sleeve parts or is formed by one of the sleeve parts. Such a guiding element can serve for the strengthening of sleeve parts corresponding with each other. Also a guiding element—which corresponds with a guiding opening in the other base part and which reaches through this guiding opening—can be formed by one of the sleeve parts. Also a sleeve part which is formed around the area of a guiding opening can serve for the guiding of a guiding element.

Thus, it can be advantageous that at least one sleeve part of the guiding device and/or at least one guiding element of the guiding device in at least one position of the at least two base parts movable relative to each other can be moved at least partly through at least one guiding opening formed in the other base part. As a result, a particularly solid guiding device—which supports the spring against buckling over the entire length in each position of the spring and in every relative position of the base parts to each other, with simultaneously occurring guiding of the base parts to each other—can be reached.

Basically, it can be of an advantage that only inside guiding device are arranged between the base parts. Thereby, a particularly space-saving force storage member and, thus, a particularly space-saving actuating drive can be provided.

It can also be of an advantage that a further spring can be arranged coaxially in the inside of the at least one spring. As a result, the range and size of the force provided by the force storage member can be increased and also the actuating drive can be better adapted to the furniture part to be actuated. Also the measures of the force storage member and, thus, of the actuating drive can be advantageous reduced. The further, coaxially arranged spring can comprise a coil direction which is opposite to the external spring.

It can also be of an advantage that the form of the guiding device substantially corresponds to the inner contour of the at least one spring. The inner contour of the spring can correspond substantially to a cylinder jacket and the guiding device, thus, substantially has a cylindrical cross section. As a result it can be reached for example that a support of the spring against buckling takes place radially in all directions and over the entire length of the spring. A play of 0.1 millimeter to 1 millimeter, preferably of about 0.3 millimeter, is provided between the guiding device and the inner contour of the springs.

Protection is also sought for an item of furniture with at least one previously described actuating drive and a furniture part movably supported on a furniture carcass of this item of furniture.

### BRIEF DESCRIPTION OF THE DRAWINGS

Further details and advantages of the present invention are described more fully hereinafter with respect to the specific description and with reference to the embodiments illustrated in the drawings, in which:

FIG. 1 shows an item of furniture in a perspective side view,

FIG. 2 is a perspective side view of an actuating drive with removed housing cover,

FIG. 3a, 3b is a side view of a sectional view of an actuating drive,

FIG. 4 is a perspective side view of a further embodiment of an actuating drive,

FIG. 5a, 5b atr perspective views of a guiding device,

FIGS. 6a-6c are perspective side views and detailed views of a force storage member,

FIG. 7a, 7b are perspective views of a force storage member in different compression positions,

FIGS. 8a-8c are different views of a force storage member in a first compression position,

FIGS. 9a-9c are different views of a force storage member in a second compression position,

FIGS. 10a-10c are different views of a further embodiment of a force storage member in a first compression position, and

FIG. 11a-11c are different views of a further embodiment of a force storage member in a second compression position.

### DETAILED DESCRIPTION OF THE INVENTION

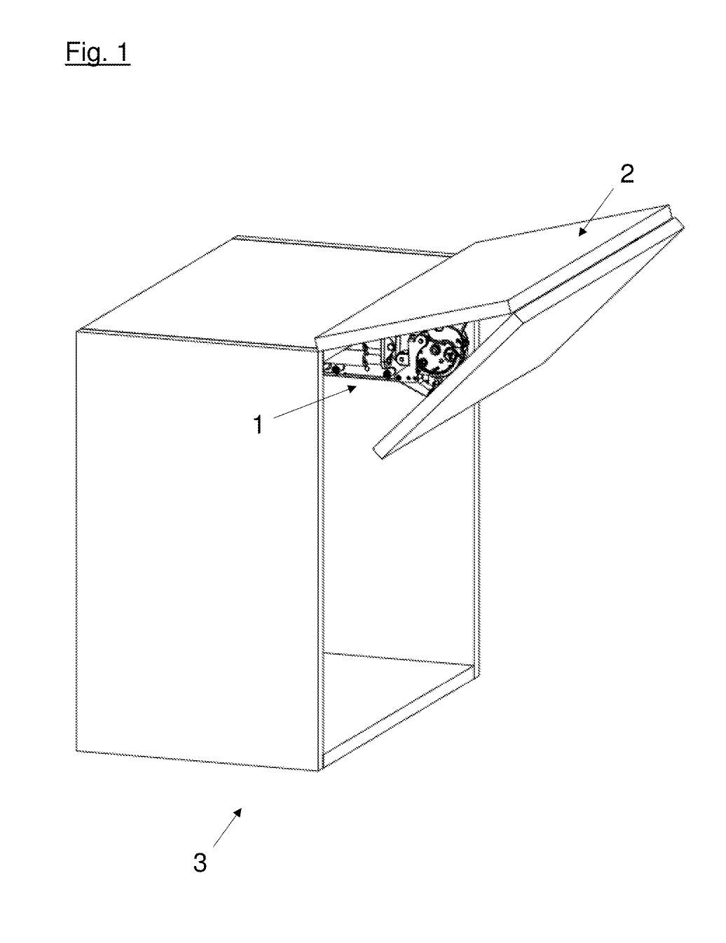

FIG. 1 is a perspective view of an item of furniture 3 with an actuating drive 1 mounted in the interior space of the item of furniture 3 and a movably supported furniture part 2 actuated by this actuating drive 1. The movable furniture part 2 is formed as a bi-fold lift flap. Different to the shown embodiment, the furniture part 2 can also be formed for example as a single front swing up flap.

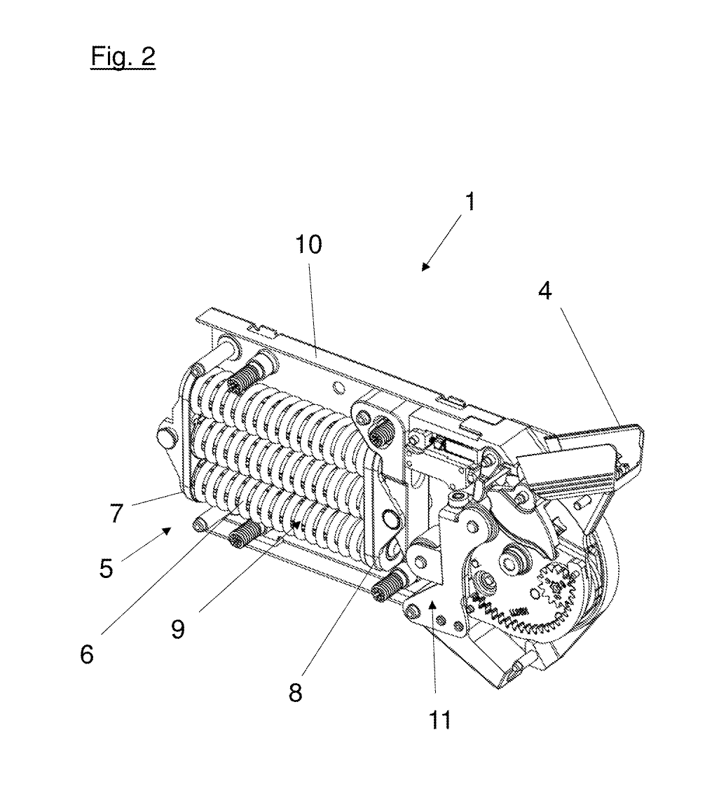

FIG. 2 shows a perspective view of an actuating drive 1 with a housing cover being removed from the housing 10. For the connection of the actuating drive 1 with furniture part 2 to be moved, the actuating drive 1 comprises an actuating arm 4. The actuating drive 1 further comprises a force storage member 5 for the force-application of the actuating arm 4. As shown, the actuating arm 1 acts upon the actuating arm 4 by means of a transmission mechanism 11 which comprises several levers. The force storage member 5 itself comprises two base parts 7, 8 being movable relative to each other, wherein in the shown embodiment the first base part 7 is pivotally supported on the housing 10 and the second base part 8 is cooperating directly with the transmission mechanism 11. The springs 6 of the force storage member 5 are arranged parallel to each other in relation to their longitudinal axes. The illustration corresponds (as can also be seen in FIG. 1) substantially to the intended mounting position of the actuating drive 1 in the item of furniture 3, wherein the springs 6 (or their longitudinal axes respectively) are arranged substantially horizontal or recumbent. As shown, the actuating arm 4 can be pivoted about a horizontal rotary axis. The force storage member 5 comprises guiding device 9 for the guiding of the springs 6 and also for the guiding of the two base parts 7, 8 to each other. The guiding device 9 is arranged in the inside of the springs 6. The guiding device 9 shall be described more fully hereinafter.

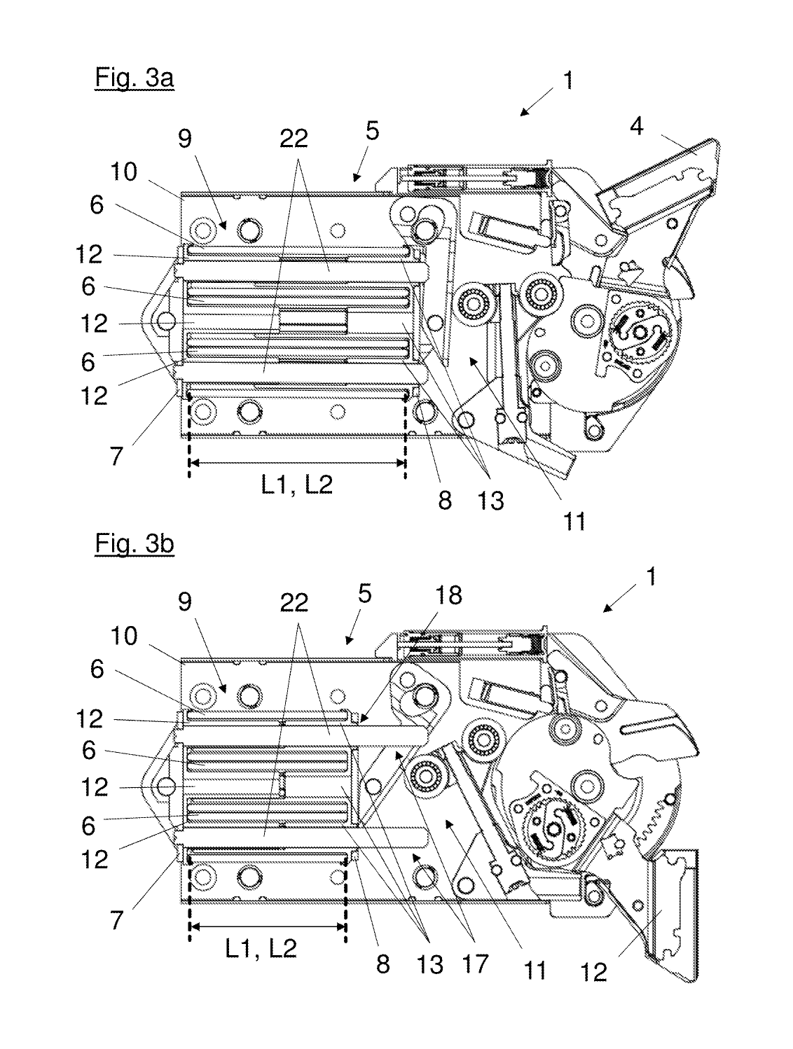

The FIGS. 3a and 3b show a side view of a sectional view of the embodiment of the actuating drive 1 shown in FIG. 2 in two different swiveling positions of the actuating drivel.

FIG. 3a shows a pivoted position of the actuating drive 1 which corresponds with an open position of a furniture part 2 of an item of furniture 3 actuated by the actuating drive 1. The force storage member 5 is in a first compression position which is characterized in that the length L1 of the springs 6 and the length L2 of the guiding device 9 substantially have a maximum value. As the length L2 of the guiding device 9 of the force storage member 5 arranged in the inside of the spring 6 can be adjusted to the length L1 of the springs 6, also in this first compression position a support of the springs 6 against a lateral—thus transverse to the longitudinal axis directed—buckling over their entire length L1 can be effected. As shown, the force storage member 5 comprises three springs 6 which are arranged parallel between the base parts 7, 8. The guiding device 9 arranged in the inside of the springs 6 is formed by the sleeve parts 12, 13, which are protruding from the base parts 7, 8 and which interlink with each other, and by guiding elements 17 here formed as bolt elements 22, wherein the guiding elements 17 project through corresponding guiding openings 18. The first sleeve parts 12 are arranged on the first base part 7 and the second sleeve parts 13 are arranged on the second base part 8. The guiding elements 17 in the form of bolt elements 22 are arranged on the first base part 7 and project through the guiding openings 18 formed in the second base part 8, wherein the sleeve parts 13 also serve for the guiding of the guiding elements 18 (see FIG. 3b).

FIG. 3b shows the actuating drive 1 in a second pivoted position which corresponds with a closed position of a furniture part 2 of an item of furniture 3 actuated by the actuating drive 1. The force storage member 5 is situated in a second compression position which is characterized in that the length L1 of the springs 6 and the length L2 of the guiding device 9 substantially have a minimum value. The two base parts 7, 8, thus, substantially have a minimal distance from each other. As the length L2 of the guiding device 9 of the force storage member 5 arranged in the inside of the spring 6 can be adjusted to the length L1 of the springs 6, also in this second compression position of the force storage member 5 a support of the springs 6 against a lateral buckling over their entire length L1 can be ensured, wherein the stroke of the force storage member 5—or the minimal possible distance between the two base parts 7, 8 respectively—is not limited by the guiding device 9. It is clearly visible in FIG. 3b that a part of the guiding device 9 can be moved through the second base part 8 in a direction facing towards the inner space of the housing 10, wherein specifically the guiding element 17 formed as a bolt element 22 projects through the guiding openings 18 formed in the second base part 8. As shown, the transmission mechanism 11 engages between the guiding elements 17 projecting from the base part 8 in the direction of the inner space of housing 10.

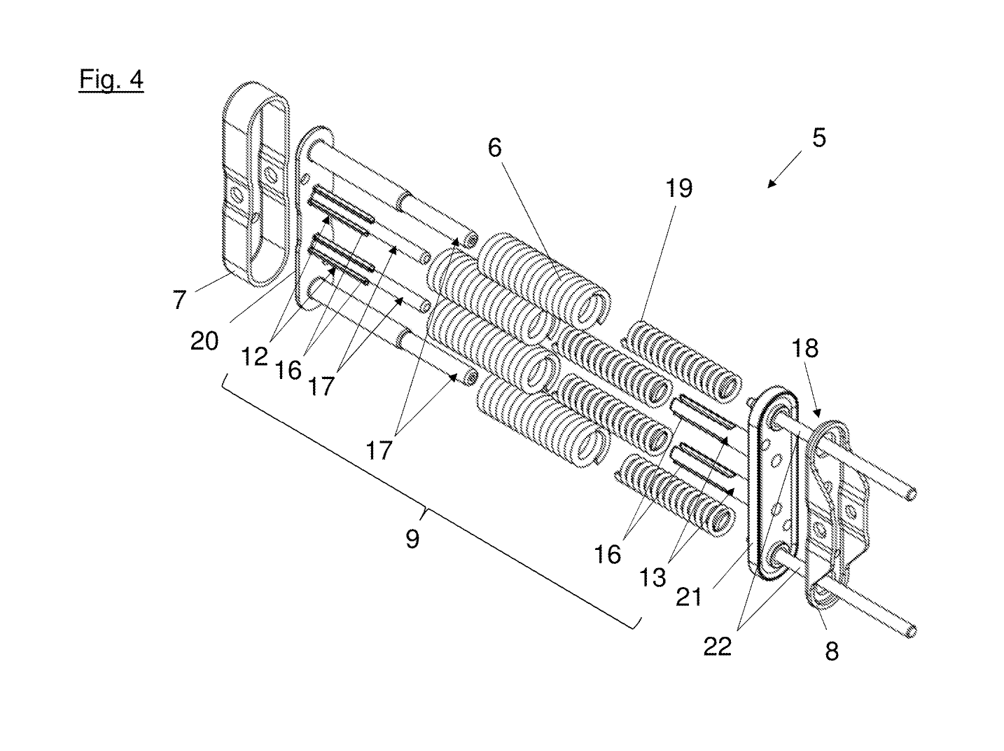

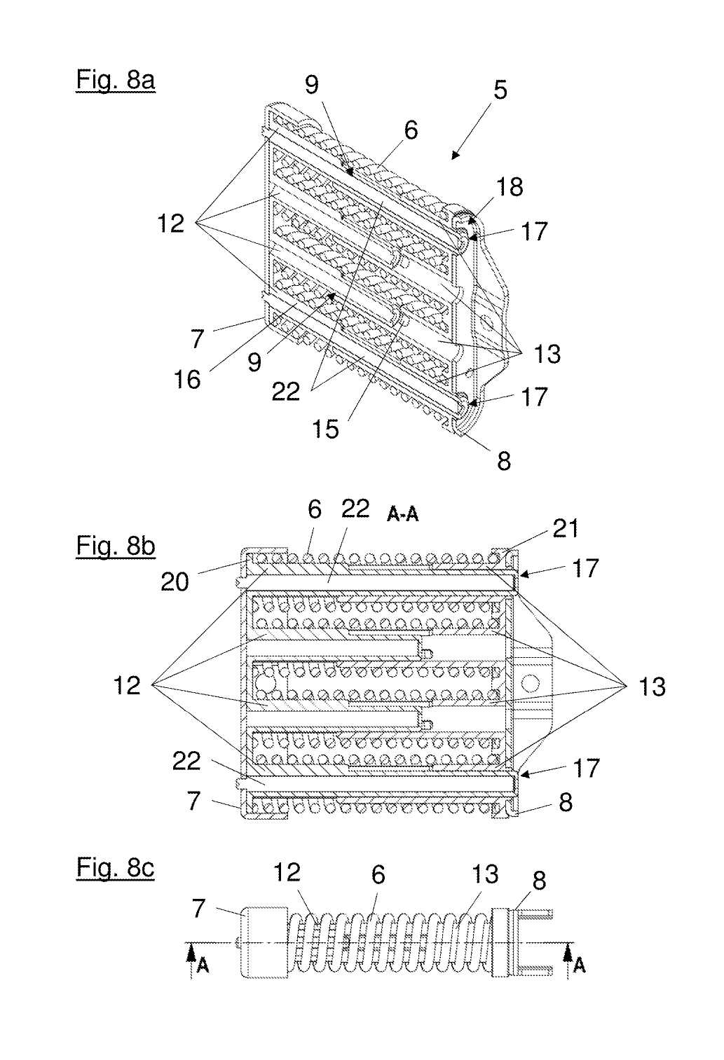

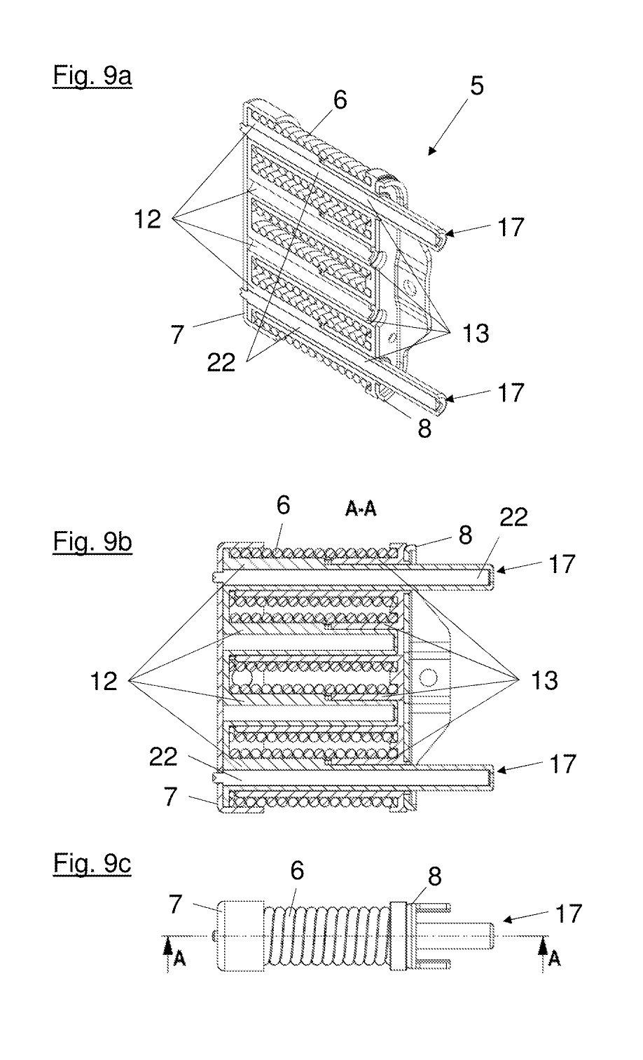

FIG. 4 shows a perspective view of a further embodiment of a force storage member 5 with springs 6, 19 which can be arranged in coaxially overlapping manner. In this embodiment the force storage member 5 again comprises a first base part 7 and a second base part 8. The guiding device 9 is formed by sleeve parts 12, 13 corresponding with each other and by guiding elements 18 which can be moved through the guiding openings 18. First sleeve parts 12 integrally formed with a basis 20 are associated to the first base part 7 and second sleeve parts 13 integrally formed with a basis 21 are associated to the second base part 8. The sleeve parts 12 comprise radially projection profile bars 16 which correspond with grooves 15 of the sleeve parts 13. Moreover, the sleeve parts 12 comprise protrusions running in longitudinal direction for the formation of guiding elements 17, which engage in a mounting state of the force storage member 5 (compare for example FIGS. 8a-8c and FIGS. 9a-9c) into the sleeve parts 13 formed on the other base part 8. Thus, in each position of the two base parts 7, 8 movable relative to each other, an overlap in radial direction and/or in circumferential direction of the sleeve parts 12, 13 can be reached, whereby a solid support of the springs 6, 19 against a lateral buckling of the springs 6, 19 is reached. In addition to the sleeve parts 12, 13 the guiding device 9 comprises—as mentioned—guiding elements 17 which are extending in longitudinal direction of the springs 6, 19 in a mounted state of the force storage member 5. The guiding elements 17 can be moved through guiding openings 18 (in this embodiment) formed in the second base part 8. Corresponding guiding openings are also formed in the basis 21, which is associated to the second base part 8. Bolt elements 22 can be provided in the inside of the guiding elements 17 for the strengthening of the guiding elements 17. Also the guiding elements 17 of the sleeve parts 12, 13 can be formed by such bolt elements 22. For example, the bolt elements 22 can be formed as steel bolts. The springs 6, 19 of the shown force storage member 5 are formed as helical springs which can be arranged coaxially (thus convoluted) to each other and are shown in a compressed state for presentation purposes.

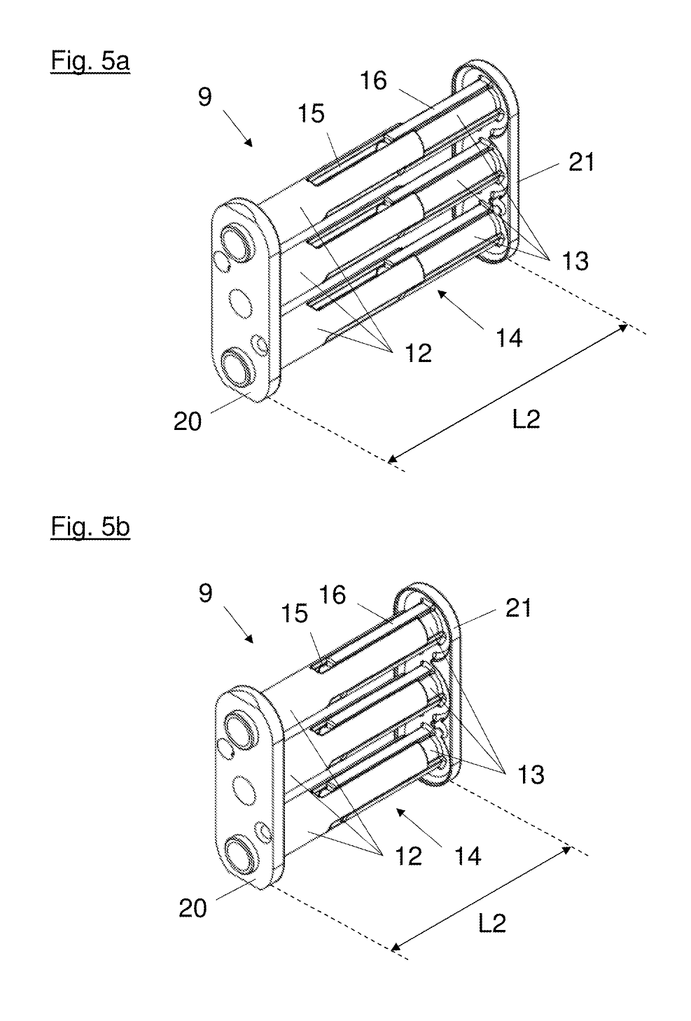

FIGS. 5a and 5b each show an embodiment of a guiding device 9 with different lengths L2 of the guiding device 9. The guiding device 9 comprises sleeve parts 12, 13 corresponding to each other. The sleeve parts 12, 13 are each formed integrally with a basis 20 or a further basis 21 respectively. In this embodiment the sleeve parts 12 of the basis 20 comprise recesses in the form of grooves 15, wherein the radially projecting profile bars 16 of the sleeve parts 13 of the further basis 21 can engage into these grooves 15. Thus, a longitudinal guiding of the sleeve parts 12, 13 to each other is reached by the grooves 15 and the profile bars 16.

In comparison to FIG. 5a, in FIG. 5b the sleeve parts 12, 13 have been moved towards each other, whereby the length L2 of the guiding device 9 is being reduced.

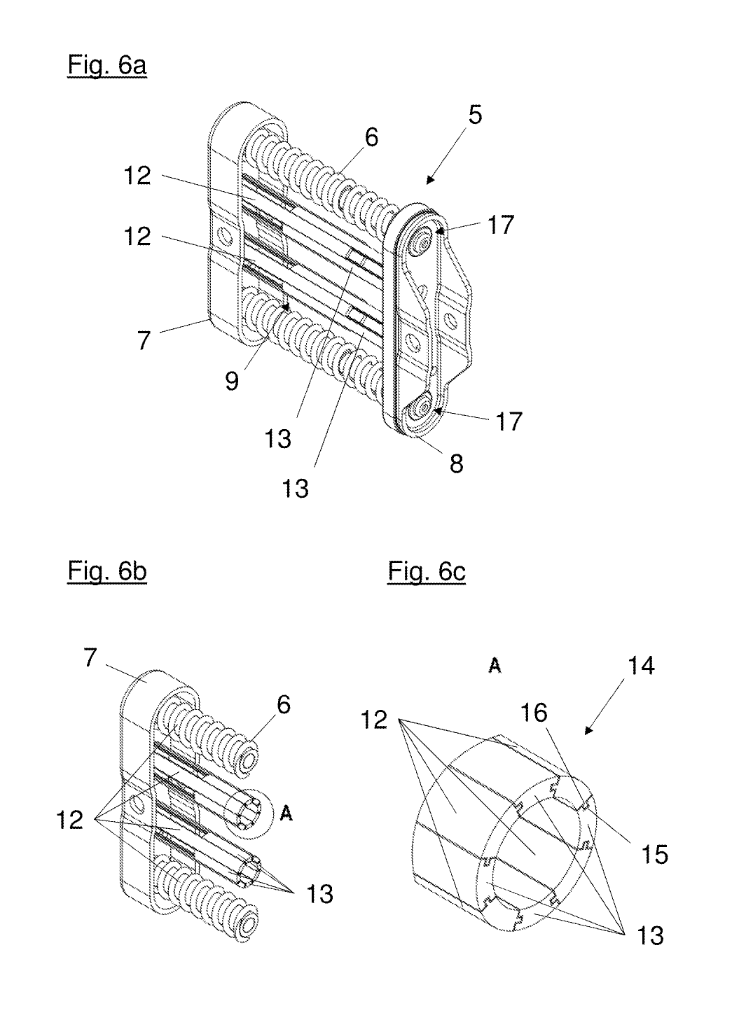

A further embodiment of the force storage member 5 is shown in FIGS. 6a-6c. Again, the guiding device 9 comprises sleeve parts 12, 13 corresponding to each other. In FIG. 6a the force storage member 5 is shown in a first compression position. FIG. 6b shows a sectional view of the force storage member 5 shown in FIG. 6a. The overlap in circumferential direction between the corresponding and engaging sleeve parts 12, 13 is visible. In FIG. 6c the detailed section A is shown scaled-up. Here it can be seen that the first sleeve parts 12 comprise profile bars 15 formed in circumferential direction, wherein the profile bars 15 engage with recesses also formed in circumferential direction and formed as grooves 15 in the second sleeve parts 13. In this way a further embodiment of a longitudinal guiding 14 of the corresponding sleeve parts 12, 13 is formed.

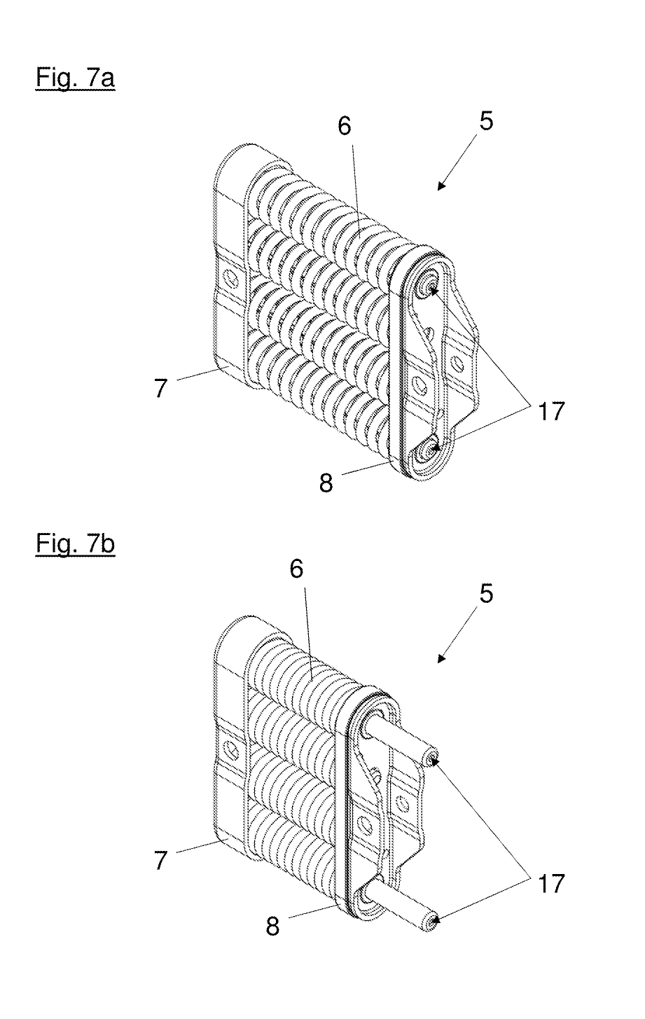

In FIGS. 7a and 7b an embodiment of a force storage member 5 in two compression positions is shown. The corresponding sectional views are shown in FIGS. 8a-8c and FIGS. 9a-9c respectively. The position of the force storage member 5 in FIG. 7a substantially corresponds to the previously mentioned first compression position and the position of the force storage member 5 shown in FIG. 7b substantially corresponds to the previously mentioned second compression position.

FIGS. 8a and 8b show a perspective view and a side view of a sectional view through the force storage member 5 along the sectional line A-A shown in FIG. 8c. It can be seen that the force storage member 5 in the shown embodiment comprises four springs 6 arranged parallel between a first base part 7 and a second base part 8. For the support of the springs 6—and also for the guiding of the relative motion of the base parts 7, 8 to each other—the force storage member 5 comprises a guiding device 9. This guiding device 9 is formed by corresponding sleeve parts 12, 13 and by guiding elements 17 extending through guiding openings 18. The guiding elements 17 are formed by the sleeve parts 12 and comprise interior bolt elements 22 for strengthening. Profile bars 16 engaging in grooves 15 are provided for the longitudinal guiding of the sleeve parts 12, 13 corresponding to each other. As shown, already in this first compression position the guiding elements 17 are partly extending through the guiding openings 18, whereby a guiding of the base parts 7, 8 to each other is reached from the beginning of the compression process. It is also visible that the sleeve parts 12, 13 corresponding to each other (as well as the guiding elements 17) are formed integrally with a basis 20 and a further basis 21 respectively. The springs 6 are being supported on the basis 20 and the further basis 21 respectively. With an appropriate material selection (for example plastic material or an appropriate coating) of the basis 20, 21 and of the sleeve parts 12, 13 corresponding to each other, a low-friction and low-noise bearing or guiding of the springs 6 can be effected.

FIGS. 9a-9c show a perspective view and a side view of a sectional view along the sectional line A-A shown in FIG. 9c. The force storage member 5, which corresponds to the embodiment of FIGS. 8a-8c, is situated in a second compression position (see also FIG. 7b) as previously mentioned. The distance of the base parts 7, 8 to each other and the stroke of the force storage member 5 relating thereto, are limited to the compressibility in the shown embodiment and not the length L2 of the guiding device 9.

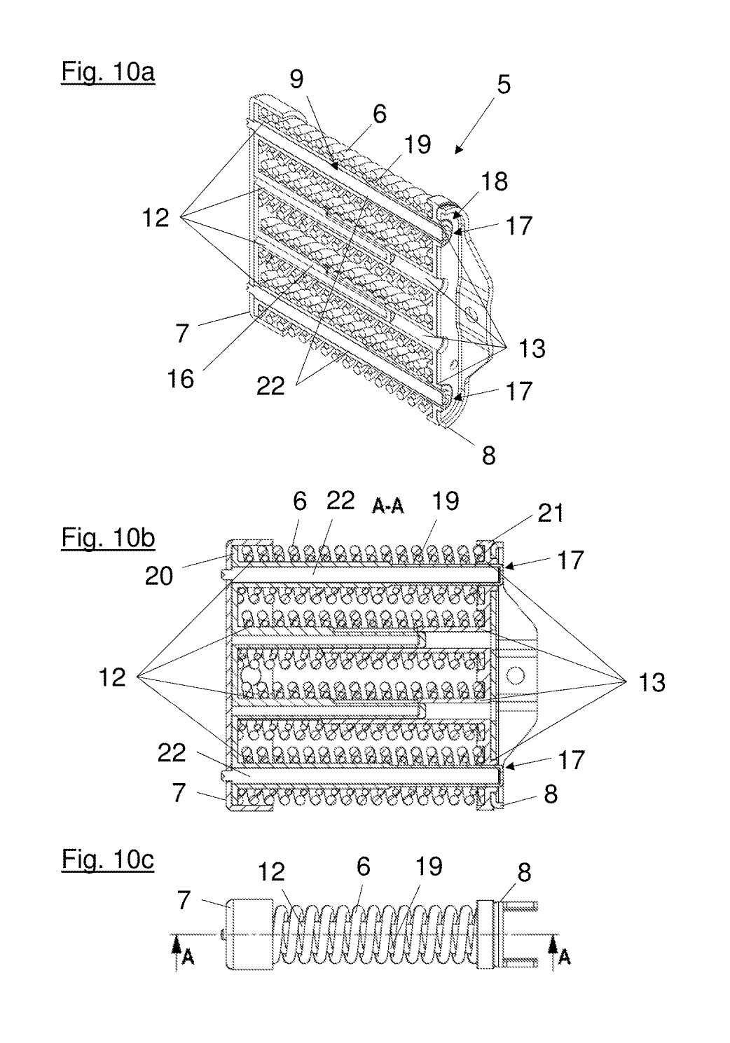

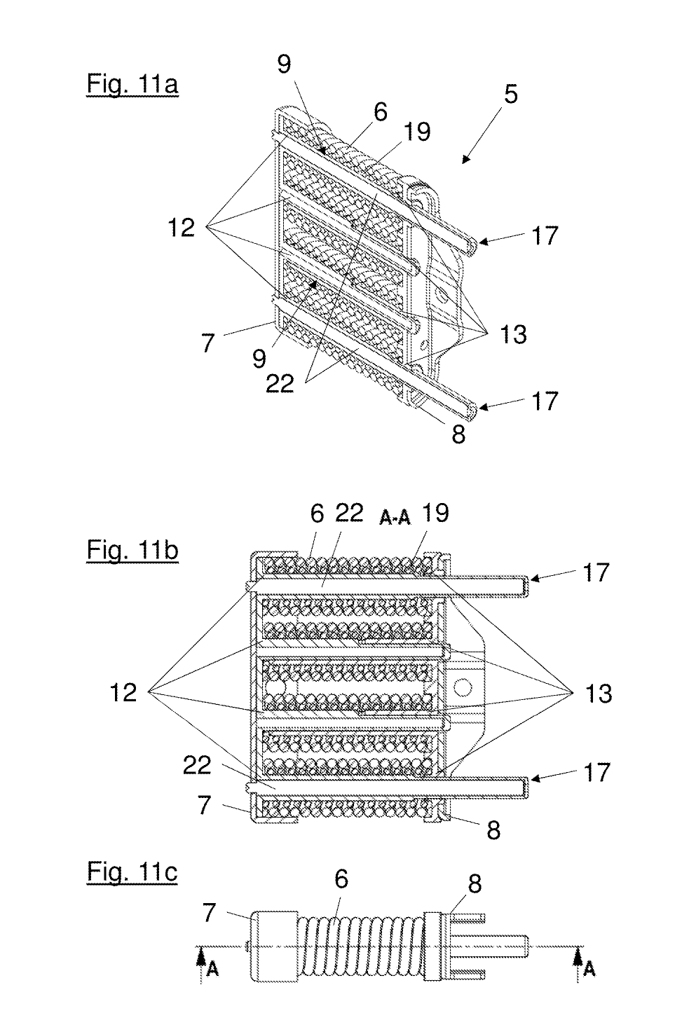

FIGS. 10a-10c and 11-11c show an embodiment of the force storage member 5 which—in contrast to the embodiment of FIGS. 8a-8c and 9a-9c—comprises four further springs 19. The four further springs 19 are arranged coaxially to the springs 6. The springs 6 and the coaxially arranged springs 19 have different coil directions (see for example FIG. 10c), whereby an entangling of the springs during a relative motion of the base parts 7, 8 to each other can be prevented. The guiding device 9 substantially corresponds to the previous embodiment.

1. An actuating drive for driving a movably supported furniture part of an item of furniture, comprising:
at least one actuating arm to be connected to the furniture part; and
a force storage member for applying force to the at least one actuating arm, wherein the force storage member has at least one spring and at least two base parts, which can be moved relative to each other and between which at least one spring is arranged, and a guiding device is arranged within the at least one spring, wherein the guiding device is designed in such a way that the guiding device supports the at least one spring against buckling of the spring over the entire length of the spring and in every position of the spring resulting from a motion of the at least two base parts relative to each other.

2. The actuating drive according to claim 1, wherein the length of the guiding device can be adapted to the length of the at least one spring.

3. The actuating drive according to claim 1, wherein during the relative motion of the at least two base parts, the guiding device can be moved—at least partly—through one of the base parts.

4. The actuating drive according to claim 3, wherein the actuating drive comprises a housing and the guiding device can be moved through one of the base parts in a direction facing an inner space of the housing.

5. The actuating drive according to claim 3, wherein the actuating drive comprises a transmission mechanism for the application of force of the at least one actuating arm by the force storage member and the transmission mechanism is cooperating—preferably directly—with the base part, through which base part the guiding device can be moved at least partly.

6. The actuating drive according to claim 1, wherein the guiding device consists of a first material—preferably plastic material—at least in areas facing towards the spring, wherein the first material is different from the second material and wherein the spring is made of the second material.

7. The actuating drive according to claim 1, wherein the guiding device comprises sleeve parts which correspond to each other, wherein the sleeve parts are arranged on the base parts and the sleeve parts are protruding from the base parts and wherein the sleeve parts in each position of the at least two base parts movable relative to each other comprise an at least partial overlap in circumferential direction and/or in radial direction.

8. The actuating drive according to claim 7, wherein the sleeve parts comprise a longitudinal guide, formed by at least one groove which is formed on a sleeve part and by a profile bar formed on the other sleeve part and being formed correspondingly with the groove.

9. The actuating drive according to claim 1, wherein the guiding device comprises at least one—preferably bolt-formed—guiding element and at least one guiding opening for the guiding element, wherein the at least one guiding element is arranged on one of the base parts and the guiding opening corresponding to the guiding element is formed on the other base part.

10. The actuating drive according to claim 5, wherein the guiding device comprises at least two guiding elements—preferably arranged parallel to each other—and at least two guiding openings which correspond with the at least two guiding elements and the transmission mechanism engages the base part substantially centrally between the guiding openings through which the guiding elements can be moved at least partly.

11. The actuating drive according to claim 7, wherein the guiding element can be arranged at least partly in one of the sleeve parts or is formed by one of the sleeve parts.

12. The actuating drive according to claim 3, wherein at least one sleeve part of the guiding device and/or at least one guiding element of the guiding device in at least one position of the at least two base parts movable relative to each other can be moved at least partly through at least one guiding opening formed in the other base part.

13. The actuating drive according to claim 1, wherein only inside guiding device are arranged between the base parts.

14. The actuating drive according to claim 1, wherein a further spring can be arranged coaxially in the inside of the at least one spring.

15. The actuating drive according to claim 1, wherein the form of the guiding device substantially corresponds to the inner contour of the at least one spring.

16. An item of furniture comprising the actuating drive according to claim 1 and a furniture part movably supported on the item of furniture.
